(19) United States
(12) Patent Application Publication
(10) Pub. No.: US 2016/0316784 A1
(43) Pub. Date: Nov. 3, 2016

(54) FAST PLASTICIZING COATING FOR FROZEN CONFECTION

(71) Applicant: NESTEC S.A., Vevey (CH)

(72) Inventor: Shantha Nalur Chandrasekaran, Leeds (GB)

(21) Appl. No.: 15/103,375

(22) PCT Filed: Nov. 28, 2014
(86) PCT No.: PCT/EP2014/075985

§ 371 Date: Jun. 10, 2016

(30) Foreign Application Priority Data
Dec. 10, 2013 (EP) 13196533.7

(51) Int. Cl. A23G 9/32

(52) U.S. Cl. CPC A23G 9/322; A23V 2002/00

(57) ABSTRACT

The invention relates to a frozen confection coating comprising based on weight % a fat in an amount of between 35-65%; an emulsifier and/or an additive, wherein a total amount of the emulsifier and/or additive is between 0.1-5%, and wherein the emulsifier and/or the additive has a melting point greater than 40 ° C. The invention also relates to a method for manufacture of the frozen confection coating.

### FIELD OF THE INVENTION

The present invention relates to a frozen confection coating and to methods of making the frozen confection coating.

### BACKGROUND

Frozen confection coatings are used to coat frozen confection such as ice cream. A frozen confection product may be covered in coating for improving the appeal and taste of the bar. In ice cream factories this is done by dipping the product into a chocolate bath or spraying the coating onto the product. In the factories, due to the dimensions of the line and the speed with which the line is operated, it is a challenge to have enough setting time for the coating between the coating of the ice cream and the packaging. Insufficient setting of the coating causes coating material to stick to the packaging machines. This results in loss of product and also loss in line time, as it is necessary to clean the equipment. Furthermore, in factories where the coating is not collected, prolonged coating dripping time causes coating waste.

Specific rheological properties of the frozen confection coating requires that the frozen confection coating effectively adheres or stays on a surface of a frozen confection in a uniform manner whilst avoiding running of the product when applied to the surface.

Frozen confection coating are conventionally made with ingredients including sugar, fat, cocoa, milk and emulsifiers such as lecithin and/or Polyglycerol Polyricinoleate (PGPR), which is a liquid at room temperature, ˜20° C. The ingredients are mixed in a mixer, adding enough fat to form a paste like consistency and then refined to lower the particle size. This can be done using a roll refiner or a ball mill. The mass is then conched and further standardized to a standard viscosity with the remaining fat and emulsifiers.

Conventionally coconut oil with high saturated fatty acid (SFA) content (90% of fat) is used in ice cream coatings. For healthier solutions coating with lower saturated fats (SFA) are desirable. However, such coatings generally include softer fat and the main issue with using the lower SFA fats, apart from softer texture, is that they take a longer time to crystallize. They are generally more runny and set slower than conventional coating. In the factory, due to the dimensions of the line and the speed with which the line is operated, there is not enough time between the dipping of the ice cream bar and the packaging. Some of the problems experienced by ice cream factories are that the insufficient setting of the coating causes coating to stick to the packaging machines. This results in loss of product and also loss in line time, as it is necessary to clean the equipment. This work was undertaken to improve the setting properties of the ice cream coatings.

There are two measurements that are considered when dipping an ice cream into a coating, 1. Drip time, this is the time that the coating drips off the ice cream before setting and 2. Dry time, this is time taken for the coating to set or dry so that it does not stick to the packaging.

Existing solutions for faster setting of coating include use of higher melting fats, such as stearin, in the coatings which allow the coating to set faster. The disadvantage are two folds, firstly the coating is waxy to taste as the higher melting fats used do not melt at the mouth temperature, secondly use of very quick setting fats can cause contraction of the fat and cracking of the coating causing pin holes and bleeders in the coated bar.

In view of the previous discussion, there are numerous challenges in providing a coating which allow fast setting of the coating without coating shrinkage and bleeding.

### SUMMARY OF THE INVENTION

It was surprisingly found that a small amount of structuring agents such as emulsifiers/additives binds fat and forms a gel with the fat in the coating. This has been found to provide a faster plasticizing and allow the coating to set faster without causing any shrinkage of the coating and subsequent bleeding.

Accordingly, the present invention relates to a frozen confection coating comprising based on weight % a fat in an amount of between 35-65%; an emulsifier and/or an additive, wherein a total amount of the emulsifier and/or additive is between 0.1-5%, and wherein the emulsifier and/or the additive has a melting point greater than 40° C.

In addition to the above-mentioned advantages the present invention allows the use of lower saturated fats (SFA) in frozen confection coatings for products such as ice cream bars or sticks with a reduced setting time and with faster drying/setting thus avoiding sticking to packaging.

It has in particular been found that emulsifiers/additives act as structuring agents by forming a gel with fat/oil and effectively plasticize the coating. The structuring agents include high melting emulsifiers having a melting point above 40° C.

By plasticizing is meant a coating that sets but does not contract, in other words it is more plastic than brittle.

A further advantage of the invention is that since the structuring agents such as the emulsifiers allow the coating to plasticize and set faster, it is possible to reduce the levels of saturated fats in the coating while still maintaining a good processing time. In general lower SFA coatings take a longer time to set however, with the added structuring agents such as the emulsifiers/additives the plasticization of the lower SFA coating allow an efficient processing.

In a second aspect the invention relates to a method for the manufacture of the frozen confection coating according to any of the above claims, comprising based on weight %:
providing fat in an amount of the coating being between 35-65% in the liquid phase;
providing an emulsifier and/or an additive having a melting point greater than 40° C. in a total amount of between 0.1-5% at any of a mixing, at conche or the end of conching before a standardisation stage, wherein the emulsifier and/or the additive is in the form of a liquid when melted or a powder.

### BRIEF DESCRIPTION OF THE FIGURE

FIG. 1 shows dipping of ice cream bar into coating.

FIG. 2 shows crystallization of fat used in coatings (coating 1) over time.

### DETAILED DESCRIPTION OF THE INVENTION

It should be appreciated that the various aspects and embodiments of the detailed description as disclosed herein are illustrative of the specific ways to make and use the invention and do not limit the scope of invention when taken into consideration with the claims and the detailed description. It will also be appreciated that features from different aspects and embodiments of the invention may be combined with features from different aspects and embodiments of the invention.

As used herein, frozen confection coating is a coating for a frozen confection. The frozen confection coating is intended to be applied to at least one surface of the frozen confection by applications known in the art such as spraying or dipping.

Without wishing to be bound by theory it is believed that the emulsifier/additive of the frozen confection coating form a gel structure with the oil/fat. We have seen that gel structure affect the ice cream coating by allowing them to plasticize faster on the frozen confection core.

By a frozen confection is meant any confection such as ice cream, milk ice, jelly, frozen yogurt, water ice products novelties which may come in various shapes, colors and flavors. They may be extruded or moulded, presented in cups or moulded in various shapes as stick bars. The frozen confection is at least partly coated with a frozen confection coating according to the invention.

In the present context an emulsifier is a molecule with one oil-loving (lipophilic) end and one water-loving (hydrophilic) end, they are generally used to stabilize an emulsion. In our particular context the high melting emulsifiers have properties to gel oil.

In the present context an additive is a molecule that is not an emulsifier but have oil gelling ability.

The fat can be any one of coconut fat, palm fat, cocoa butter fat, mango fat, shea fat, illepe fat, canola fat, peanut fat, sunflower fat, rapeseed fat, grape-seed fat, cotton-seed fat, soybean fat, corn fat or any combination thereof. It is to be appreciated that the term fat also encompasses fats that are solids or liquids at room temperature and the term fat is also understood to encompass oils and lipids.

The fat can be present in an amount of preferably between 40-60%. The fat is more preferably present in an amount between 45-55%.

The emulsifier and/or the additive is preferably present based on weight % in a total amount of between 0.25-3%. The emulsifier and/or the additive is more preferably present based on weight % in a total amount of between 0.25-1%.

The invention has been found particular useful for low saturated fat coating. In a preferred embodiment of the invention the fat in the coating comprises below 50% wt saturated fatty acid, more preferably below 30% wt based on the weight of the fat in the coating.

Preferably the frozen confection coating according to the invention comprises fat or blend of fats having an N10 value lower than 70% and more preferably below 60%. The N10 value of a fat is the percentage of the fat that is solid at 10° C. N values can be measured using pulsed Nuclear Magnetic Resonance method according to ISO standards.

The emulsifier and/or the additive is preferably present based on weight % in an amount of between 0.1-5%, more preferably between 0.25-3%. The emulsifier and/or the additive is even more preferably present based on weight % in an amount of between 0.25-1%. This allows to obtain the right coating pick-up weight while still obtaining a decreased drying time. For example the drying time can be decreased with up to 50% or even higher, e.g. from a drying time of >150 seconds to a drying time below 50 seconds.

The emulsifier and/or the additive preferably has a melting point greater than 40° C. It has been observed that when the emulsifier and/or the additive has a melting point lower than 40° C., the plasticisation of the fat is not so effective. The higher melting point give faster setting but the pick-up time should not be too high because this results in too much coating material. A preferred melting point for the emulsifier and/or the additive is in the range 55 to 75° C. In this range there is a good balance between pick up of coating material on the frozen confectionery product and the plasticisation.

The emulsifier includes monoglycerides derived from plant and animal sources. The emulsifier includes monoglycerides derivatives such as diacetyl tartaric esters of monoglycerides (DATEM), acetic acid esters of monoglycerides (ACETEM), succinic acid esters of monoglycerides (succinylated monoglycerides (SMG)), lactic acid esters of monoglycerides (LACTEM), citric acid esters of monoglycerides (CITREM), ethoxylated mono and diglycerides. The emulsifiers include polyglycerol esters such as hexaglyceryl distearate, hexaglyceride monostearate and triglyceryl monostearate. The emulsifier includes sorbitan esters and sugar esters. Preferred emulsifiers are monoglycerides and their derivatives, diglycerides and hexaglyceryl distearate. A combination of the above-mentioned emulsifiers may be used.

Preferred additive includes ethyl cellulose, waxes, such as bees wax, carnauba wax and plant derived wax such as candelilla wax, berry wax and sunflower wax or combination thereof.

The emulsifier and/or the additive can be any one of the aforementioned or any combinations thereof.

The frozen confection coating preferably has a particle size of below 60 microns. It is noted that where the frozen confection coating has a particle size of greater than 60 microns a sandy/gritty texture is observed in the frozen confection coating which should be avoided. The frozen confection coating preferably has a particle size of between 20-35 microns.

The frozen confection coating has a yield value of less than 3 dynes/cm². Yield value (also known as yield stress) is a measurable quantity similar to, but not dependent on, viscosity. It can be thought of as the initial resistance to flow under stress. The yield value and plastic viscosity are measured using a Brookfield Viscometer (DV-I, DV-II, DV-II+, and DV-III Brookfield Viscometer) with the Casson calculation mode used according to the manufacturer's instructions.

The frozen confection coating can further comprise based on weight %, cocoa powder in an amount of between 0-20%.

The frozen confection coating can further comprise based on weight %, lecithin in amount of between 0-1.0%. It has been found that when lecithin is used, lecithin lowers the plastic viscosity of the of the frozen confection coating. This has the advantage that a flow of the frozen confection coating is improved making it easier to pump and spray the frozen confection coating.

The frozen confection coating can further comprise based on weight %, milk powder or whey powder in an amount of between 0-30%. A purpose of the milk powder or the whey powder is to provide a milk flavour to the frozen confection coating.

The coating composition of the present invention may further include one or more additional ingredients such as flavors, sweeteners, colorants, antioxidants (e.g. lipid antioxidants), or a combination thereof. Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such as maltitol, xylitol, sorbitol, erythritol, mannitol, isomalt, lactitol, hydrogenated starch hydrolysates, and the like, alone or in combination.

Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used.

The frozen confection coating can further comprise based on weight %, sweetener in amount of between 20-60%.

The frozen confection coating can further comprise a flavouring to make up the total weight % of the frozen confection coating.

The invention further provides a method for the manufacture of the frozen confection comprising based on weight %:
providing fat in an amount between 35-65% in the liquid phase
providing an emulsifier and/or an additive having a melting point greater than 40° C. in a total amount of between 0.1-5% at any of a mixing, at conche or the end of conching before a standardisation stage, wherein the emulsifier and/or the additive is in the form of a liquid when melted or a powder.

The method may advantageously be used with any combination of preferred embodiment of the frozen confection coating formulations mentioned in the application.

When the emulsifier and/or the additive have a relatively low melting point they are in liquid form. When the emulsifier and/or the additive have a relatively high melting point they are in the form of a powder with particle sizes in the range of between 10-20 microns.

During the mixing stage the ingredients that make up frozen confection coating are blended in a mixer to form a mass with a dough-like consistency. The mass with the dough-like consistency is crushed to form refined mass-flakes. The mass with the dough-like consistency can be crushed by any means known in the art. However it is preferable that the mass with the dough-like consistency is crushed by rollers as rollers form consistently sized refined mass-flakes.

The conche or conching stage is a flavour development stage. During the conche or conching stage the aforementioned refined mass-flakes are subjected to constant agitation by a conching machine as known in the art. The conching machine agitates the refined mass-flakes by means of large paddles that agitate the refined mass-flakes by sweeping back and forth through a mass of the refined mass-flakes. The conch or conching stage can be carried out for a period of a few hours. The conche or conching stage ensures an even dispersion of flavours in the ensuing ice-cream coating. The conche or conching stage reduces moisture in the ensuing ice-cream coating. The conche or conching stage drives off any undesirable flavours in the ensuing ice-cream coating. Such undesirable flavours can be for example acidic flavours that may result from the ingredients used in the manufacture of the frozen confection coating.

During the standardisation stage, the mass from the conche or conching stage is either held in holding tanks for further use and then standardised or standardised right away from the conche. During the standardisation stage the mass may be adjusted with by the addition of further fat and emulsifier and/or an additive to obtain desired rheological properties in the ensuing frozen confection coating.

The present inventors have found that the emulsifier and/or additive can be used melted or in the form of a powder and can be added to the fat at any of a mixing stage, at conche stage or even at the end of the conching stage before a standardisation stage. It was surprisingly found that the addition of the emulsifier and/or additive melted or in the form of a powder at any of the above stages remains effective in its functionality irrespective of at which stage of the manufacturing process it is added.

Thus the method according to the present invention enables ease of incorporation of the emulsifier and/or additive during the manufacture of the frozen confection coating as the emulsifier and/or additive can be used as a dry ingredient.

### EXAMPLES

By way of example and no limitation, the following examples are illustrative of various embodiments of the present disclosure.

### Example 1

The effect of the structuring agents was tested in two lower SFA coating with different fat content and different SFA content. Coating 1 (high fat low SFA coating) has 60% fat and a SFA content of 25%, the formulation of which is given in table 1.

A high fat low SFA coating was made to the formulation as below:

TABLE 1
Coating 1 Formulation

| Ingredients | % wt |
|---|---|
| Sugar | 25.8 |
| fat-CBE | 35.5 |
| Canola | 23.7 |
| Cocoa | 13.0 |
| skim milk powder | 1.7 |
| Lecithin | 0.3 |
| Total | 100.0 |
| % fat | 60.9 |
| % SFA in coating | 24.6 |

The saturated fat in this coating is 25% and it takes a long time to set (>150 seconds). To this coating we have added structuring agents and tested the drip and dry time.

Incorporation of the Emulsifier/Additives into the Coating

A weighed amount of the emulsifier/additive was added to the melted coating and the coating was heated up to 60° C-70° C. and stirred until the additive is visibly melted/solubilized. This coating was then cooled down and maintained at 39-41° C. for dipping experiments.

Dipping Experiments

The low SFA coating (control) and the coating with added additive/emulsifier were maintained at a temperature between 39-41° C. in a tempering beaker. The ice cream bars, which were maintained between -20 to -24° C., were dipped into the coating, the time between the dipping till the last drop stopped dripping was noted (dripping time). The dryness of the coating to the touch is the drying or setting time. Eight bars were dipped for each treatment and the coating weight pick up, drip and dry time was recorded.

Table 1 shows the dipping data of the ice cream bars. Coating 1 is the low SFA coating which has a long dry time (>150 sec), this long dry time is not practical on the Industrial line. Treatment 1 has 1% wt of added emulsifier (hexaglyceryl distearate), the drip time and dry time are considerably shorter as compared to the low SFA coating with no additive. However, the shorter drip time allows for more pick-up weight of the coating. This can be circumvented by either slightly raising the coating temperature (42-45° C.), or adjusting the coating rheology or decreasing the levels of the structuring agent. Treatments 2 and 3 have lower levels of emulsifier, the drip time and weight pick up is similar to the control however the dry time is significantly decreased. It is important that the levels of additive, coating rheology and coating and ice cream temperature be optimized to get the right coating pick-up with a lowered dry time.

TABLE 2
Coating Dipping data

| | Coating weight | Drip | Dry |
|---|---|---|---|
| Coating | pick-up | time | time (sec) |
| Coating 1: Low SFA coating (25% | 11.1 | 7.8 | >150 |
| SFA) | | | |
| Coating 1 + 1% wt hexaglyceryl | 14.5 | 5.2 | 34 |
| distearate (HGDS Kosher) | | | |
| Coating 1 + 0.5% wt HGDS Kosher | 11.4 | 7.5 | 24.3 |
| Coating 1 + 0.5% wt monoglyceride | 11.1 | 8.0 | 26.3 |
| (melting point 67° C.) | | | |

### Example 2

Coating 2 was a lower fat coating compared to coating 1 and it contained only 14% SFA. The lower fat, lower SFA coating was made to the formulation as given below:

TABLE 3
Coating 2 Formulation

| | % wt |
|---|---|
| Sugar | 42.64 |
| CBE | 17.19 |
| sunflower oil | 20.99 |
| Cocoa | 12.48 |
| Skim milk powder | 6.19 |
| Lecithin | 0.50 |
| Total | 100.00 |
| % fat | 40.05 |
| SFA in coating | 14% |

Table 4 shows the dipping data of the ice cream bars. Coating 2 is the lower fat low SFA coating which has a long dry time (>150 sec), this long dry time is not practical on the Industrial line. Treatment 1 has a 0.5% wt of candelilla wax, the drip time and dry time are considerably shorter as compared to the low SFA coating with no additive. The shorter drip time allows for more pick-up weight of the coating. This can be addressed by adding a lower level of the structuring agent. Treatment 2 has only 0.25% of the wax, the drip time and weight pick up is similar to the control however the dry time is significantly decreased. Again it is important that the levels of additive, coating rheology and coating and ice cream temperature be optimized to get the right coating pick-up with a lowered dry time

TABLE 4
Coating Dipping data

| | Coating | | |
|---|---|---|---|
| | weight | Drip time | Dry time |
| Coating | pick-up | (sec) | (sec) |
| Coating 2: Lower fat low SFA | 16.2 | 13 | >150 |
| coating (14% SFA) | | | |
| Coating 2 + 0.5% wt Candelilla wax | 21.0 | 7.5 | 40 |
| Coating 2 + 0.25% wt Candelilla wax | 16.8 | 13 | 26.2 |
| Coating 2 + 0.25% wt monoglycerides | 17.0 | 13 | 38 |
| (melting point 72° C.) | | | |

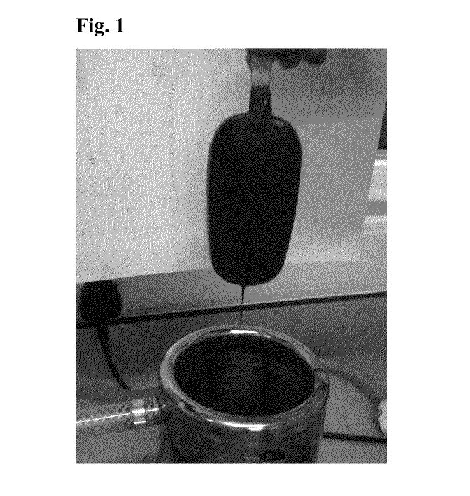

FIG. 1 is a picture of the dipping of the frozen confection.

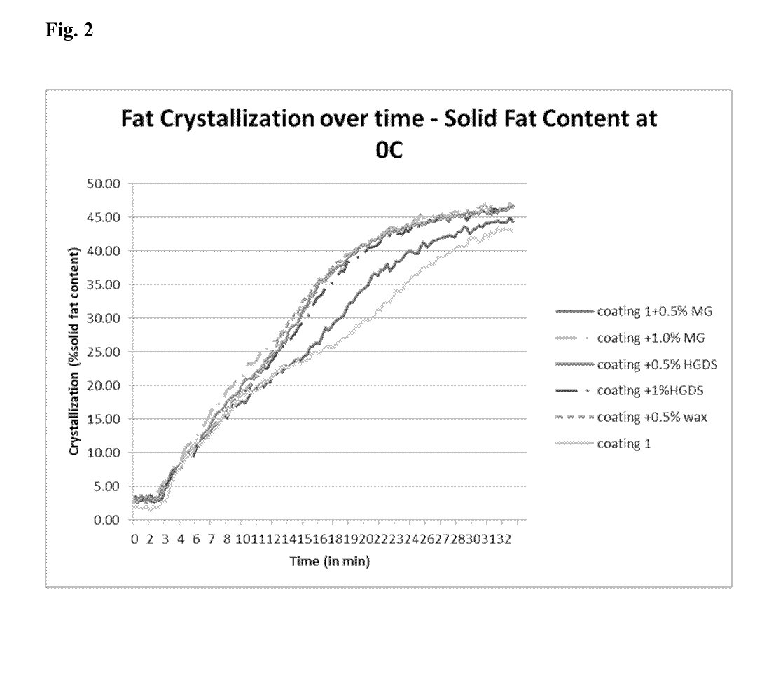

FIG. 2 gives the crystallization/setting properties of fats containing the structuring agents over time.

Fat Crystallization by Pulsed NMR

The fat crystallization was measured by pulsed-nuclear magnetic resonance (pulsed NMR, Resonance Instruments Ltd., Witney, U.K.). Approximately 2 g of well melted fat was placed in a 10 mm NMR tube. The sample was melted well at 70C, brought down to 40 C and then placed in the NMR, which was maintained at OC. Measurements were taken every 2 seconds for 30-35 min, by a programmed script. This gave the solid fat content of the fat over time, which gives an indication of the fat crystallization.

As can be seen in FIG. 2, the structuring agents produce more solid fats over time, which in turn is related to the drying of the coating. The 1% wt level of the monoglycerides (MG) dries/sets faster than the control and the coating with 0.5% wt monoglycerides. A similar trend was seen with the emulsifier hexaglyceryl distearate (HGDS), while the waxes set faster even at 0.5% wt level and had to be reduced to 0.25% wt to help with the weight pick up while still helping with the drying/setting time.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A frozen confection coating comprising based on weight % fat in an amount of between 35-65%; an emulsifier and/or an additive, wherein a total amount of the emulsifier and/or additive is between 0.1-5%, and wherein the emulsifier and/or the additive has a melting point greater than 40° C.

2. A frozen confection coating according to claim 1, wherein the fat is present in an amount of between 40-60%.

3. A frozen confection coating according to claim 1, wherein the emulsifier and/or additive is present in an amount of between 0.25-3%.

4. The frozen confection coating according to claim 1, wherein the fat is selected from the group consisting of coconut, palm, cocoa butter, mango, shea, illepe, canola, peanut, sunflower, rapeseed, grape-seed, cotton-seed, soybean, corn fat, and combinations thereof.

5. The frozen confection coating according to claim 1, wherein the emulsifier is selected from the group consisting of:
monoglycerides derived from plant and animal sources;
monoglycerides derivatives selected from diacetyl tartaric esters of monoglycerides (DATEM), acetic acid esters of monoglycerides (ACETEM), succinic acid esters of monoglycerides (SMG), lactic acid esters of monoglycerides (LACTEM), citric acid esters of monoglycerides (CITREM), ethoxylated mono and diglyceride;
polyglycerol esters selected from hexaglyceryl distearate, hexaglyceride monostearate and triglyceryl monostearate; and
sorbitan esters, sugar esters, and combinations thereof.

6. The frozen confection coating according to claim 1, wherein the additive is selected from the group consisting of ethyl cellulose, waxes such as bees wax, carnauba wax and a plant derived wax such as candelilla wax, berry wax, sunflower wax, and combinations thereof.

7. The frozen confection coating according to claim 1, wherein a particle size of the coating is below 60 microns.

8. The frozen confection coating according to claim 1, wherein a yield value of the coating is less than 3 dynes/cm2.

9. The frozen confection coating according to claim 1 further comprising based on weight %, at least one sugar in amount of between 2-60%.

10. The frozen confection coating according to claim 1 further comprising based on weight %, cocoa powder in an amount of between 0-20%.

11. The frozen confection coating according to claim 1 further comprising based on weight %, lecithin in amount of between 0-1.0%.

12. The frozen confection coating according to claim 1 further comprising based on weight %, milk powder or whey powder in an amount of between 0-30%.

13. The frozen confection coating according to claim 1, wherein the fat in the coating comprises below 50% wt saturated fatty acid.

14. The frozen confection coating according to claim 1, wherein the fat or blend of fats having an N10 value lower than 70% and more preferably below 60%.

15. A method for the manufacture of the frozen confection coating comprising based on weight %:
providing fat in an amount between 35-65% in a liquid phase; and
providing an emulsifier and/or an additive having a melting point greater than 40° C. in a total amount of between 0.1-5% at any of a mixing, at conche or the end of conching before a standardisation stage, wherein the emulsifier and/or the additive is in the form of a liquid when melted or a powder.
